(19) United States
(12) Patent Application Publication
(10) Pub. No.: US 2025/0324389 A1
(43) Pub. Date: Oct. 16, 2025

(54) METHOD AND APPARATUS FOR REQUESTING TO POSITION TERMINAL, AND DEVICE AND STORAGE MEDIUM

(71) Applicant: Beijing Xiaomi Mobile Software Co., Ltd., Beijing (CN)

(72) Inventor: Xiaolong LI, Beijing (CN)

(21) Appl. No.: 18/866,307

(22) PCT Filed: May 20, 2022
(86) PCT No.: PCT/CN2022/094146

§ 371 Date: Nov. 15, 2024

(51) Int. Cl. H04W 64/00; H04W 8/08

(52) U.S. Cl. CPC H04W 64/003; H04W 8/08

(57) ABSTRACT

A terminal positioning request method is performed by a network device. The method includes: transmitting a request message to an access and mobility management function (AMF) network element or a location management function (LMF) network element, wherein the request message makes a request to perform at least one of positioning a terminal or obtaining location information of the terminal.

### CROSS-REFERENCE TO RELATED APPLICATION

This application is the U.S. national phase application of International Application No. PCT/CN2022/094146, filed on May 20, 2022, the disclosure of which is incorporated herein by reference in its entirety.

### TECHNICAL FIELD

The present disclosure relates to the field of mobile communications, and in particular, to a terminal positioning request method, apparatus, device and storage medium.

### BACKGROUND

The 5th generation mobile communication technology (5G) new radio (NR) introduces a variety of positioning technologies to achieve terminal positioning.

In a non-terrestrial network (NTN) system, a terminal may report its location information, determined by means of a global navigation satellite system (GNSS), to a base station. However, such location information may be subject to manipulation, and it is therefore expected to be able to verify on the network device whether the location information reported by the terminal is reliable or not. At present, the location information of the terminal obtained by a location management function (LMF) network element via a location service (LCS) is reliable and may be used to determine whether the location information of the terminal has been manipulated.

For positioning the terminal via an LCS procedure, the related art supports the terminal, an access and mobility management function (AMF) network element, or an external LCS agent to initiate a positioning request. The approach for requesting to position the terminal requires further discussion and research.

### SUMMARY

Examples of the present disclosure provide a terminal positioning request method, apparatus, device, and storage medium. The technical solutions are as follows.

According to one aspect of the present disclosure, a terminal positioning request method is provided, performed by a network device. The method includes: transmitting a request message to an access and mobility management function (AMF) network element or a location management function (LMF) network element, wherein the request message makes a request to perform at least one of: positioning a terminal or obtaining location information of the terminal.

According to another aspect of the present disclosure, a terminal positioning request method is provided, performed by an LMF network element. The method includes: receiving a request message transmitted by a network device, wherein the request message makes a request to perform at least one of: positioning a terminal or obtain location information of the terminal.

According to another aspect of the present disclosure, a terminal positioning request method is provided, performed by an AMF network element. The method includes: receiving a request message transmitted by a network device, wherein the request message makes a request to perform at least one of: positioning a terminal or obtaining location information of the terminal.

The technical solutions provided by the present disclosure include at least the following beneficial effects.

By transmitting a request message, which makes a request to position a terminal and/or obtain location information of the terminal, from a network device to an AMF network element or an LMF network element, it is achieved to initiate a positioning request for the terminal by a base station, thereby being able to flexibly initiate the positioning request for the terminal.

### BRIEF DESCRIPTION OF THE DRAWINGS

The drawings related to the description of the examples will be briefly introduced to explain the technical solutions provided by examples of the present disclosure more clearly. It is obvious that, the drawings in the following description illustrate only some examples of the present disclosure.

FIG. 1 is a schematic diagram of an NTN scenario based on transparent forwarding according to an example of the present disclosure.

FIG. 2 is a schematic diagram of an NTN scenario based on regenerative forwarding according to an example of the present disclosure.

FIG. 3 is a schematic diagram of an LCS-based positioning procedure according to an example of the present disclosure.

FIG. 4 is a flowchart of a terminal positioning request method according to an example of the present disclosure.

FIG. 5 is a flowchart of a terminal positioning request method according to an example of the present disclosure.

FIG. 6 is a flowchart of a terminal positioning request method according to an example of the present disclosure.

FIG. 7 is a flowchart of a terminal positioning request method according to an example of the present disclosure.

FIG. 8 is a flowchart of a terminal positioning request method according to an example of the present disclosure.

FIG. 9 is a flowchart of a terminal positioning request method according to an example of the present disclosure.

FIG. 10 is a flowchart of a terminal positioning request method according to an example of the present disclosure.

FIG. 11 is a flowchart of a terminal positioning request method according to an example of the present disclosure.

FIG. 12 is a flowchart of a terminal positioning request method according to an example of the present disclosure.

FIG. 13 is a flowchart of a terminal positioning request method according to an example of the present disclosure.

FIG. 14 is a structural diagram of a terminal positioning request apparatus according to an example of the present disclosure.

FIG. 15 is a structural diagram of a terminal positioning request apparatus according to an example of the present disclosure.

FIG. 16 is a structural diagram of a terminal positioning request apparatus according to an example of the present disclosure.

FIG. 17 is a schematic structural diagram of a communication device according to an example of the present disclosure.

### DETAILED DESCRIPTION OF THE EMBODIMENTS

In order to make the purpose, technical solutions and advantages of the present disclosure clearer, the implementations of the present disclosure will be further described in detail below in conjunction with the accompanying drawings.

Examples will be described in detail herein, whose instances are illustrated in the accompanying drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the present disclosure are for the purpose of describing particular examples only and are not intended to limit the present disclosure. Terms determined by “a,” “said” and “the” in their singular forms in the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be used in the present disclosure to describe various information, such information should not be limited to these terms. These terms are only used to distinguish the information of the same type with each other. For example, without departing from the scope of the present disclosure, first information may be referred to as second information; and similarly, second information may also be referred to as first information. Depending on the context, the word “if” as used herein may be interpreted as “when,” “upon,” or “in response to determining”.

### Introduction to an NTN System

At present, the 3rd generation partnership project (3GPP) is studying a non-terrestrial network (NTN) technology, which generally uses satellite communications to provide communication services for ground users. Compared with terrestrial cellular network communications, the satellite communications have many unique advantages. Firstly, the satellite communications are not limited by the geographical locations of the users. For example, general land communications cannot cover oceans, mountains, deserts and other areas where communication equipment cannot be set up or where there is no communication coverage due to sparse population. With the satellite communications, a single satellite can cover a larger area, and the satellites can orbit the earth. Theoretically, therefore, the satellite communications can cover every corner of the earth. Secondly, the satellite communications have a great social value. With the satellite communications, remote mountainous areas and poor and backward countries or regions can be covered at a relatively low cost, allowing people in these areas to enjoy advanced voice communications and mobile Internet technologies, which is conducive to narrowing a digital divide with the developed regions and promoting the development of these areas. Thirdly, the satellite communications support long distances without a significant increase in communication costs as the communication distance increases. Finally, the satellite communications are highly stable and are not subject to the effects of natural disasters.

The communication satellites are divided into low-earth orbit (LEO) satellites, medium-earth orbit (MEO) satellites, geostationary earth orbit (GEO) satellites, high elliptical orbit (HEO) satellites, etc. according to their orbital altitudes. At present, the main research focus is on the LEO and the GEO.
1. LEO. The low orbit satellites have the altitudes between 500 km and 1500 km and corresponding orbital periods of approximately 1.5 hours to 2 hours, with signal propagation delays of typically less than 20 ms for single-hop communications between users, and a maximum satellite visibility time of 20 minutes. Due to short signal propagation distance and low link loss, the transmission power requirements for user equipment are not high.
2. GEO. The geosynchronous orbit satellites have an orbital altitude of 35786 km and an orbital period around the earth of 24 hours, with typical signal propagation delays of 250 ms for single-hop communications between users.

In order to ensure the satellite coverage and improve the system capacity of the entire satellite communication system, the satellites use multiple beams to cover the ground. A single satellite may form dozens or even hundreds of beams to cover the ground, and a single satellite beam may cover a ground area with a diameter of tens to hundreds of kilometers.

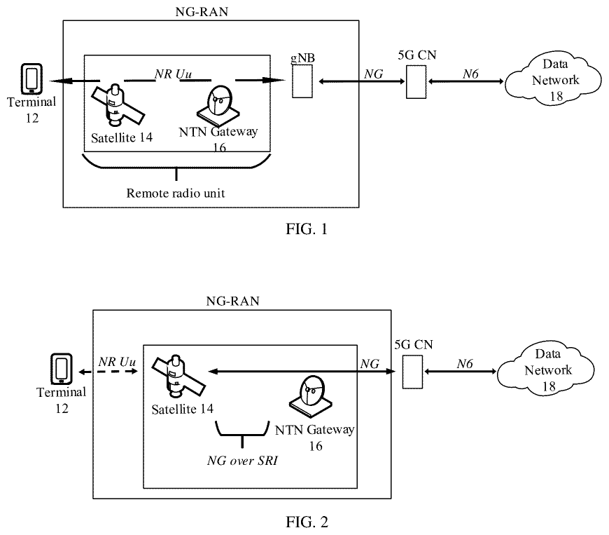

There are two types of satellites considered by 3GPP at the current stage, satellites with transparent forwarding (also called transparent payload) and satellites with regenerative forwarding (also called regenerative payload). For example, FIG. 1 is a schematic diagram of an NTN scenario based on the transparent forwarding according to an example of the present disclosure, and FIG. 2 is a schematic diagram of an NTN scenario based on the regenerative forwarding according to an example of the present disclosure.

A feeder link refers to a wireless link between Satellite 14 and NTN Gateway 16 that is usually located on the ground.

Schematically, an NTN network includes the following network elements.
One or more gateways, which are configured to connect a satellite and a terrestrial public network.
The feeder link, which is a link used for communications between the gateway and the satellite.
A service link, which is a link used for communications between a terminal and the satellite.
The satellite, which may be divided into two types, the transparent payload and the regenerative payload, based on the functions it provides.
The transparent payload, which provides only wireless frequency filtering, frequency conversion and frequency amplification functions. It provides only the transparent forwarding of signals, without changing the forwarded wave signals.
The regenerative payload, which provides demodulation/decoding, routing/conversion, encoding/modulation functions in addition to the wireless frequency filtering, frequency conversion and frequency amplification functions. It includes some or all of the functions of a base station.
An inter-satellite link (ISL), which exists in the regenerative payload scenario.

It is to be noted that the NTN network involves NR-Uu, NG, and N6 interfaces. In the regenerative payload scenario, the NG interface of the feeder link is over Satellite Radio Interface (SRI). It is to be noted that a terminal in the examples of the present disclosure may refer to user equipment (UE), an access terminal, a user unit, a user station, a mobile station, a mobile console, a remote station, a remote terminal, a mobile device, a wireless communication device, a user agent or a user device. Alternatively, or additionally, the terminal may also be a cellular phone, a cordless phone, a session initiation protocol (SIP) phone, a wireless local loop (WLL) station, a personal digital assistant (PDA), a handheld device with wireless communication functions, a computing device or another processing device connected to a wireless modem, a vehicle-mounted device, a wearable device, a terminal in a 5th generation system (5GS) or a terminal in a future evolved public land mobile network (PLMN), etc., which is not limited in the examples of the present disclosure.

An access network device in the examples of the present disclosure is a device deployed in an access network to provide wireless communication functions for the terminals. The access network device may include various forms, such as a macro base station, a micro base station, a relay station, and an access point. In systems adopting different wireless access technologies, the device with the access network device functions may have different names. For example, it is called gNodeB or gNB in 5G new radio (NR) systems. As communication technologies evolve, the name “access network device” may change. For ease of description, the described devices for providing wireless communication functions for the terminals are collectively called the access network devices in the examples of the present disclosure. Alternatively, or additionally, a communication relationship may be established between the terminal and a core network (CN) device through the access network device. For example, in a long term evolution (LTE) system, the access network device may be an evolved universal terrestrial radio access network (EUTRAN) or one or more eNode B in the EUTRAN; and in the 5G NR system, the access network device may be a radio access network (RAN) or one or more gNBs in the RAN.

A core network device has the functions focused on providing connections for users, managing the users and achieving service bearing, considered as an interface that is provided from a bearer network to the external network. For example, the core network devices in the 5G NR system may include access and mobility management function (AMF) entities, user plane function (UPF) entities, session management function (SMF) entities and location management function (LMF) entities, etc. The access network devices and the core network devices may be collectively referred to as network devices. The examples of the present disclosure are described by taking an example where an LMF network element and an AMF network element are the core network devices.

### Introduction to Terminal Positioning

At present, the terminal may report its location information to the base station in the NTN system. The location information is determined by the terminal by means of a global navigation satellite system (GNSS) based on its GNSS positioning capability. For example, the base station may use the location information of the terminal in the following aspects.
Selecting an appropriate AMF network element based on the location information of the terminal. For example, the area where the terminal is located is determined based on the location information of the terminal, and then the AMF network element deployed in the area where the terminal is located is selected for the terminal.
Determining a corresponding tracking area and a tracking area code based on the location information of the terminal, and transmitting the involved information to the AMF network element.
Constructing a cell global ID (CGI) based on the location information of the terminal, and transmitting the CGI to the AMF network element.

In the NTN system, the location information of the terminal determined by means of the GNSS may be subject to manipulation, and it is therefore expected to be able to verify on the network side whether the location information reported by the terminal and determined by means of the GNSS is reliable or not. At present, the location information of the terminal obtained by the LMF network element via a location service (LCS) is reliable and may be used to determine whether the location information of the terminal has been manipulated. The LCS, as a positioning function introduced by the NR, may achieve obtaining the location of the terminal.

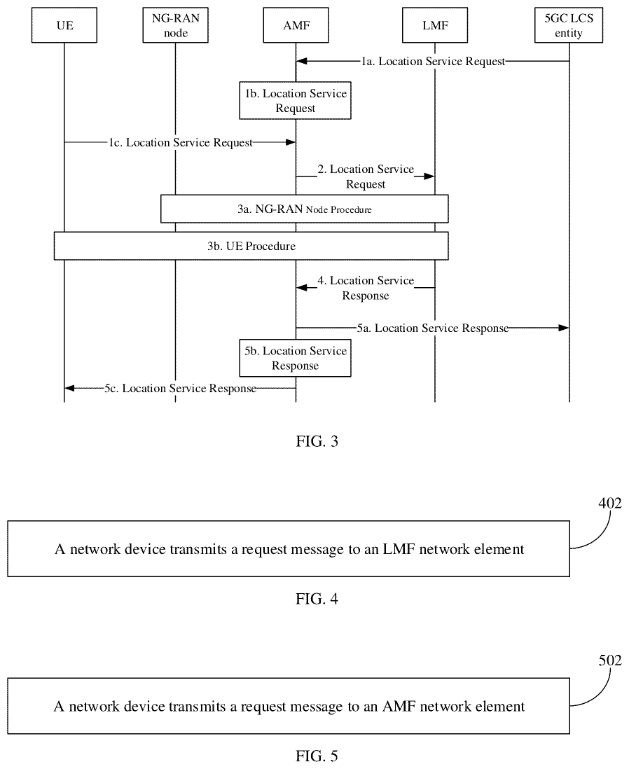

For example, FIG. 3 is a schematic diagram of an LCS-based positioning procedure according to an example of the present disclosure. As illustrated in FIG. 3, in the LCS-based positioning procedure, the positioning request may be initiated by the terminal, that is, the terminal transmits a location service request to the AMF network element at step 1c. The positioning request may be initiated by the AMF network element, that is, the AMF network element initiates the location service request at step 1b. The positioning request may be initiated by an external LCS agent, that is, a 5G core network (5GC) LCS entity transmits the location service request to the AMF network element at step 1a. After initiating or receiving the location service request, the AMF network element transmits a location service request to the LMF network element. Then, the LMF network element triggers a 5G access network (e.g., an NG-RAN) node procedure at step 3a or triggers a UE procedure at step 3b to obtain the location information of the terminal. At step 4, the LMF network element transmits a location service response to the AMF network element to feed back the location information of the terminal to the AMF network element. After receiving the location service response, the AMF network element feeds back a location service response to the initiator of the location service request, which includes feeding back the location service response to the 5GC LCS entity at step 5a, obtaining the location service response by itself at step 5b, or feeding back the location service response to the terminal at step 5c.

At present, when positioning the terminal via the LCS procedure, it is supported that the terminal, the AMF network element or the external LCS agent initiates the positioning request, as illustrated in FIG. 3, but isn't supported that the base station (e.g., an NG-RAN node) initiates the positioning request for the terminal. According to the methods provided in the examples of the present disclosure, by transmitting the request message, which makes a request to position the terminal and/or obtain the location information of the terminal, from the network device (e.g., the base station) to the AMF network element or the LMF network element, it can be achieved to initiate the positioning request for the terminal by the base station, and it is thereby achieved to flexibly initiate the positioning request for the terminal.

FIG. 4 illustrates a flowchart of a terminal positioning request method according to an example of the present disclosure. The method may be applied to a network device. The method includes the following steps.

At step 402, a request message is transmitted to an LMF network element.

The request message makes a request to position a terminal and/or obtain location information of the terminal. Alternatively, or additionally, when it is expected to verify the location information determined by means of a GNSS and reported by the terminal, the network device transmits the request message to the LMF network element. For example, the network device is a base station such as a gNB. Alternatively, or additionally, the request message is a location service request.

Alternatively, or additionally, the request message requests the LMF network element to initiate a positioning request for the terminal in accordance with a positioning procedure. The positioning procedure is a procedure for positioning the terminal based on an LCS. For example, the positioning procedure is the procedure for positioning the terminal as illustrated in FIG. 3.

Alternatively, or additionally, the request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of a positioning capability based on uplink time difference of arrival (UL-TDOA) or a positioning capability based on uplink angle of arrival (UL-AOA). The positioning technology recommended by the network device include at least one of a UL-TDOA technology, a UL-AOA technology or a downlink time difference of arrival (DL-TDOA) technology.

Alternatively, or additionally, when transmitting the described request message to the LMF network element, the network device transmits a new radio positioning protocol A (NRPPa) message to the LMF network element, with the NRPPa message carrying the request message. The NRPPa message includes at least one of a UE associated new NRPPa message or a non-UE association NRPPa message.

After receiving the described request message, the LMF network element initiates a positioning request for the terminal in accordance with the positioning procedure in response to the request message, so as to obtain the location information of the terminal and/or a positioning measurement result. That is, the location information of the terminal and/or the positioning measurement result are obtained by the LMF network element according to the positioning request. Alternatively, or additionally, the positioning procedure is a procedure for positioning the terminal based on an LCS. For example, after receiving the described request message, the LMF network element performs step 3a or step 3b in the procedure as illustrated in FIG. 3, so as to obtain the location information of the terminal and/or the positioning measurement result. Then, the LMF network element transmits the location information of the terminal and/or the positioning measurement result to the network device. Alternatively, or additionally, the LMF network element transmits the location information of the terminal and/or the positioning measurement result to the network device through an NRPPa message. The NRPPa message includes at least one of the UE association NRPPa message or the non-UE be called a location service response.

In view of the above, by transmitting the request message, which makes a request to position the terminal and/or obtain the location information of the terminal, from the network device to the LMF network element according to the method provided in the example, it is achieved to initiate the positioning request for the terminal by the base station, thereby being able to flexibly initiate the positioning request for the terminal.

FIG. 5 illustrates a flowchart of a terminal positioning request method according to an example of the present disclosure. The method may be applied to a network device. The method includes the following steps.

At step 502, a request message is transmitted to an AMF network element.

The request message makes a request to position a terminal and/or obtain location information of the terminal. Alternatively, or additionally, when it is expected to verify the location information determined by means of a GNSS and reported by the terminal, the network device transmits the request message to the AMF network element. For example, the network device is a base station such as a gNB. Alternatively, or additionally, the request message is a location service request.

Alternatively, or additionally, the request message requests the AMF network element to initiate a positioning request for the terminal in accordance with a positioning procedure. The positioning procedure is a procedure for positioning the terminal based on an LCS. For example, the positioning procedure is the procedure for positioning the terminal as illustrated in FIG. 3.

Alternatively, or additionally, the request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of a positioning capability based on UL-TDOA or a positioning capability based on UL-AOA. The positioning technology recommended by the network device includes at least one of a UL-TDOA technology, a UL-AOA technology or a DL-TDOA technology.

Alternatively, or additionally, when transmitting the request message to the AMF network element, the network device transmits the described request message to the AMF network element through a next generation (NG) interface.

After receiving the described request message, the AMF network element transmits a positioning request message to an LMF network element in response to the request message, so as to trigger the LMF network element to initiate the positioning request for the terminal in accordance with the positioning procedure. Alternatively, or additionally, the positioning request message is the location service request. The LMF network element initiates the positioning request for the terminal in accordance with the positioning procedure, so as to obtain the location information of the terminal and/or a positioning measurement result. Then, the LMF network element transmits the location information of the terminal and/or the positioning measurement result to the AMF network element. That is, the location information of the terminal and/or the positioning measurement result obtained by the AMF network element are obtained by the LMF network element according to the positioning request and transmitted to the AMF network element. Alternatively, or additionally, the positioning procedure is the procedure for positioning the terminal based on the LCS. For example, still referring to FIG. 3, the LMF network element performs step 3a or step 3b after receiving the described positioning request message (at step 2), so as to obtain the location information of the terminal and/or the positioning measurement result. Then, the LMF network element transmits the location information of the terminal and/or the positioning measurement result to the AMF network element (e.g., transmitting a location service response at step 4).

Alternatively, or additionally, the positioning request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of the positioning capability based on UL-TDOA or the positioning capability based on UL-AOA. The positioning technology recommended by the network device includes at least one of the UL-TDOA technology, the UL-AOA technology or the DL-TDOA technology. Alternatively, or additionally, the information in the described request message is identical to or different from the information in the positioning request message.

After obtaining the location information of the terminal and/or the positioning measurement result, the AMF network element transmits the location information of the terminal and/or the positioning measurement result to the network device. Alternatively, or additionally, the AMF network element transmits the location information of the terminal and/or the positioning measurement result to the network device through the NG interface. The message transmitted by the AMF network element may also be called a location service response.

In view of the above, by transmitting the request message, which makes a request to position the terminal and/or obtain the location information of the terminal, from the network device to the AMF network element according to the method provided in the example, it is achieved to initiate the positioning request for the terminal by the base station, thereby being able to flexibly initiate the positioning request for the terminal.

FIG. 6 illustrates a flowchart of a terminal positioning request method according to an example of the present disclosure. The method may be applied to an LMF network element. The method includes the following steps.

At step 602, a request message transmitted by a network device is received.

The request message makes a request to position a terminal and/or obtain location information of the terminal. For example, the network device is a base station such as a gNB. Alternatively, or additionally, the request message is a location service request.

Alternatively, or additionally, the request message requests the LMF network element to initiate a positioning request for the terminal in accordance with a positioning procedure. The positioning procedure is a procedure for positioning the terminal based on an LCS. For example, the positioning procedure is the procedure for positioning the terminal as illustrated in FIG. 3.

Alternatively, or additionally, the request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of a positioning capability based on UL-TDOA or a positioning capability based on UL-AOA. The positioning technology recommended by the network device includes at least one of a UL-TDOA technology, a UL-AOA technology or a DL-TDOA technology.

Alternatively, or additionally, the LMF network element receives the described request message by receiving an NRPPa message transmitted by the network device, with the NRPPa message carrying the request message. The NRPPa message includes at least one of a UE association NRPPa message or a non-UE association NRPPa message.

After receiving the described request message, the LMF network element initiates a positioning request for the terminal in accordance with a positioning procedure in response to the request message, so as to obtain the location information of the terminal and/or a positioning measurement result. That is, the location information of the terminal and/or the positioning measurement result are obtained by the LMF network element according to the positioning request. Alternatively, or additionally, the positioning procedure is a procedure for positioning the terminal based on an LCS. For example, after receiving the described request message, the LMF network element performs step 3a or step 3b in the procedure as illustrated in FIG. 3, so as to obtain the location information of the terminal and/or the positioning measurement result.

After obtaining the location information of the terminal and/or the positioning measurement result, the LMF network element transmits the location information of the terminal and/or the positioning measurement result to the network device. Alternatively, or additionally, the LMF network element transmits the location information of the terminal and/or the positioning measurement result to the network device through an NRPPa message. The NRPPa message includes at least one of the UE association NRPPa message or the non-UE association NRPPa message. The message transmitted by the LMF network element may also be called a location service response.

In view of the above, by transmitting the request message, which makes a request to position the terminal and/or obtain the location information of the terminal, from the network device to the LMF network element according to the method provided in the example, it can be achieved to initiate the positioning request for the terminal by the base station, and it is thereby achieved to flexibly initiate the positioning request for the terminal.

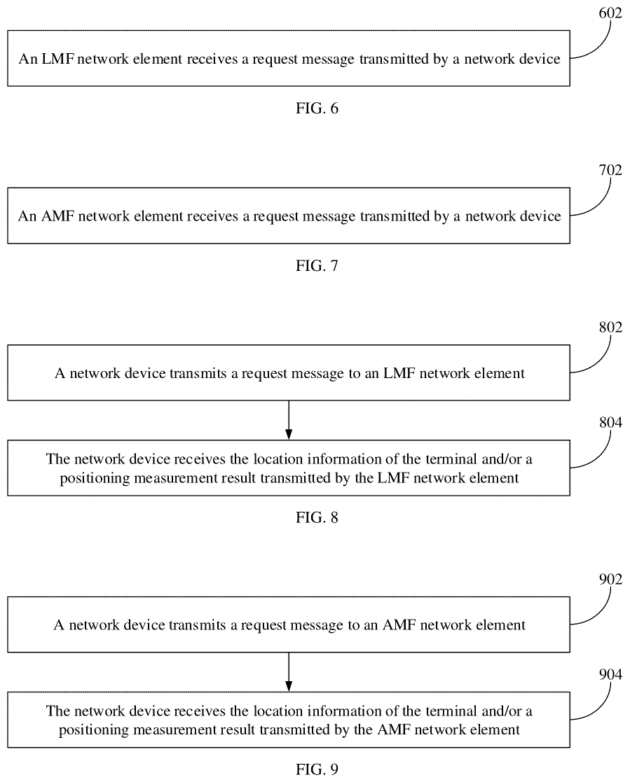

FIG. 7 illustrates a flowchart of a terminal positioning request method according to an example of the present disclosure. The method may be applied to an AMF network element. The method includes the following steps.

At step 702, a request message transmitted by a network device is received.

The request message makes a request to position a terminal and/or obtain location information of the terminal. For example, the network device is a base station such as a gNB. Alternatively, or additionally, the request message is a location service request.

Alternatively, or additionally, the request message requests the AMF network element to initiate a positioning request for the terminal in accordance with a positioning procedure. The positioning procedure is a procedure for positioning the terminal based on an LCS. For example, the positioning procedure is the procedure for positioning the terminal as illustrated in FIG. 3.

Alternatively, or additionally, the request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of a positioning capability based on UL-TDOA or a positioning capability based on UL-AOA. The positioning technology recommended by the network device includes at least one of a UL-TDOA technology, a UL-AOA technology or a DL-TDOA technology.

Alternatively, or additionally, when transmitting the request message to the AMF network element, the network device transmits the described request message to the AMF network element through an NG interface.

After receiving the described request message, the AMF network element transmits a positioning request message to an LMF network element in response to the request message, so as to trigger the LMF network element to initiate the positioning request for the terminal in accordance with the positioning procedure. Alternatively, or additionally, the request message is the location service request. The LMF network element initiates the positioning request for the terminal in accordance with the positioning procedure, so as to obtain the location information of the terminal and/or a positioning measurement result. Then, the LMF network element transmits the location information of the terminal and/or the positioning measurement result to the AMF network element. That is, the location information of the terminal and/or the positioning measurement result obtained by the AMF network element are obtained by the LMF network element according to the positioning request and transmitted to the AMF network element. Alternatively, or additionally, the positioning procedure is the procedure for positioning the terminal based on the LCS. For example, still referring to FIG. 3, the LMF network element performs step 3a or step 3b after receiving the described positioning request message (at step 2), so as to obtain the location information of the terminal and/or the positioning measurement result.

After obtaining the location information of the terminal and/or the positioning measurement result, the LMF network element transmits the location information of the terminal and/or the positioning measurement result to the AMF network element (e.g., transmitting the location service response at step 4).

Alternatively, or additionally, the positioning request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of the positioning capability based on UL-TDOA or the positioning capability based on UL-AOA. The positioning technology recommended by the network device includes at least one of the UL-TDOA technology, the UL-AOA technology or the DL-TDOA technology. Alternatively, or additionally, the information in the described request message is identical to or different from the information in the positioning request message.

After obtaining the location information of the terminal and/or the positioning measurement result, the AMF network element transmits the location information of the terminal and/or the positioning measurement result to the network device. Alternatively, or additionally, the AMF network element transmits the location information of the terminal and/or the positioning measurement result to the network device through the NG interface. The message transmitted by the AMF network element may also be called a location service response.

In view of the above, by transmitting the request message, which makes a request to position the terminal and/or obtain the location information of the terminal, from the network device to the AMF network element according to the method provided in the example, it can be achieved to initiate the positioning request for the terminal by the base station, and it is thereby achieved to flexibly initiate the positioning request for the terminal.

FIG. 8 illustrates a flowchart of a terminal positioning request method according to an example of the present disclosure. The method may be applied to a network device. The method includes the following steps.

At step 802, a request message is transmitted to an LMF network element.

The request message makes a request to position a terminal and/or obtain location information of the terminal. For example, the network device is a base station such as a gNB. Alternatively, or additionally, the request message is a location service request.

Alternatively, or additionally, the request message requests the LMF network element to initiate a positioning request for the terminal in accordance with a positioning procedure. The positioning procedure is a procedure for positioning the terminal based on an LCS. For example, the positioning procedure is the procedure for positioning the terminal as illustrated in FIG. 3.

Alternatively, or additionally, the request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of a positioning capability based on UL-TDOA or a positioning capability based on UL-AOA. The positioning technology recommended by the network device includes at least one of a UL-TDOA technology, a UL-AOA technology or a DL-TDOA technology.

Alternatively, or additionally, when transmitting the described request message to the LMF network element, the network device transmits an NRPPa message to the LMF network element, with the NRPPa message carrying the request message. The NRPPa message includes at least one of a UE association NRPPa message or a non-UE association NRPPa message.

At step 804, the location information of the terminal and/or a positioning measurement result transmitted by the LMF network element is received.

After receiving the described request message, the LMF network element initiates a positioning request for the terminal in accordance with the positioning procedure in response to the request message, so as to obtain the location information of the terminal and/or the positioning measurement result. That is, the location information of the terminal and/or the positioning measurement result are obtained by the LMF network element according to the positioning request. Alternatively, or additionally, the positioning procedure is the procedure for positioning the terminal based on the LCS.

After obtaining the location information of the terminal and/or the positioning measurement result, the LMF network element transmits the location information of the terminal and/or the positioning measurement result to the network device. Alternatively, or additionally, the LMF network element transmits the location information of the terminal and/or the positioning measurement result to the network device through an NRPPa message. The NRPPa message includes at least one of the UE association NRPPa message or the non-UE be called a location service response.

In view of the above, by transmitting the request message, which makes a request to position the terminal and/or obtain the location information of the terminal, from the network device to the LMF network element according to the method provided in the example, it can be achieved to initiate the positioning request for the terminal by the base station, and it is thereby achieved to flexibly initiate the positioning request for the terminal.

FIG. 9 illustrates a flowchart of a terminal positioning request method according to an example of the present disclosure. The method may be applied to a network device. The method includes the following steps.

At step 902, a request message is transmitted to an AMF network element.

The request message makes a request to position a terminal and/or obtain location information of the terminal. For example, the network device is a base station such as a gNB. Alternatively, or additionally, the request message is a location service request.

Alternatively, or additionally, the request message requests the LMF network element to initiate a positioning request for the terminal in accordance with a positioning procedure. The positioning procedure is a procedure for positioning the terminal based on an LCS. For example, the positioning procedure is the procedure for positioning the terminal as illustrated in FIG. 3.

Alternatively, or additionally, the request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of a positioning capability based on UL-TDOA or a positioning capability based on UL-AOA. The positioning technology recommended by the network device includes at least one of a UL-TDOA technology, a UL-AOA technology or a DL-TDOA technology.

Alternatively, or additionally, when transmitting the request message to the AMF network element, the network device transmits the described request message to the AMF network element through an NG interface.

At step 904, the location information of the terminal and/or a positioning measurement result transmitted by the AMF network element is received.

After receiving the described request message, the AMF network element transmits a positioning request message to an LMF network element in response to the request message, so as to trigger the LMF network element to initiate the positioning request for the terminal in accordance with the positioning procedure. Alternatively, or additionally, the request message is the location service request. The LMF network element initiates the positioning request for the terminal in accordance with the positioning procedure, so as to obtain the location information of the terminal and/or the positioning measurement result. Then, the LMF network element transmits the location information of the terminal and/or the positioning measurement result to the AMF network element. That is, the location information of the terminal and/or the positioning measurement result obtained by the AMF network element are obtained by the LMF network element according to the positioning request and transmitted to the AMF network element. Alternatively, or additionally, the positioning procedure is the procedure for positioning the terminal based on the LCS.

After obtaining the location information of the terminal and/or the positioning measurement result, the LMF network element transmits the location information of the terminal and/or the positioning measurement result to the AMF network element.

Alternatively, or additionally, the positioning request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of the positioning capability based on UL-TDOA or the positioning capability based on UL-AOA. The positioning technology recommended by the network device includes at least one of the UL-TDOA technology, the UL-AOA technology or the DL-TDOA technology. Alternatively, or additionally, the information in the described request message is identical to or different from the information in the positioning request message.

After obtaining the location information of the terminal and/or the positioning measurement result, the AMF network element transmits the location information of the terminal and/or the positioning measurement result to the network device. Alternatively, or additionally, the AMF network element transmits the location information of the terminal and/or the positioning measurement result to the network device through the NG interface. The message transmitted by the AMF network element may also be called a location service response.

In view of the above, by transmitting the request message, which makes a request to position the terminal and/or obtain the location information of the terminal, from the network device to the AMF network element according to the method provided in the example, it can be achieved to initiate the positioning request for the terminal by the base station, and it is thereby achieved to flexibly initiate the positioning request for the terminal.

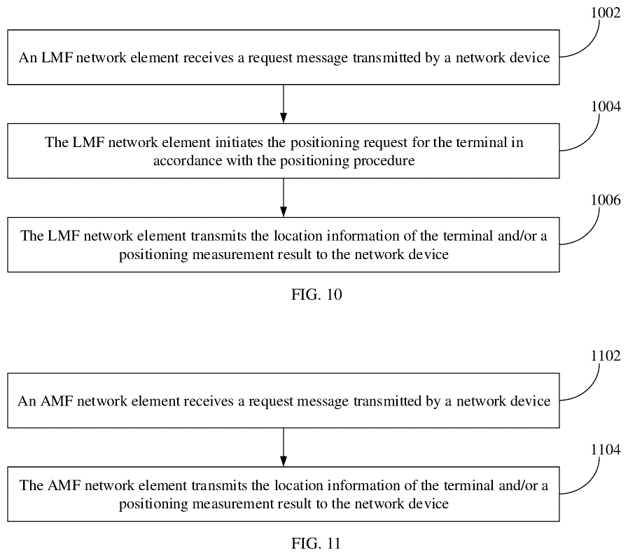

FIG. 10 illustrates a flowchart of a terminal positioning request method according to an example of the present disclosure. The method may be applied to an LMF network element. The method includes the following steps.

At step 1002, a request message transmitted by a network device is received.

The request message makes a request to position a terminal and/or obtain location information of the terminal. For example, the network device is a base station such as a gNB. Alternatively, or additionally, the request message is a location service request.

Alternatively, or additionally, the request message requests the AMF network element to initiate a positioning request for the terminal in accordance with a positioning procedure. The positioning procedure is a procedure for positioning the terminal based on an LCS. For example, the positioning procedure is the procedure for positioning the terminal as illustrated in FIG. 3.

Alternatively, or additionally, the request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of a positioning capability based on UL-TDOA or a positioning capability based on UL-AOA. The positioning technology recommended by the network device includes at least one of a UL-TDOA technology, a UL-AOA technology or a DL-TDOA technology.

Alternatively, or additionally, the LMF network element receives the described request message by receiving an NRPPa message transmitted by the network device, with the NRPPa message carrying the request message. The NRPPa message includes at least one of a UE association NRPPa message or a non-UE association NRPPa message.

At step 1004, the positioning request for the terminal is initiated in accordance with the positioning procedure.

After receiving the described request message, the LMF network element initiates the positioning request for the terminal in accordance with the positioning procedure in response to the request message, so as to obtain the location information of the terminal and/or a positioning measurement result. That is, the location information of the terminal and/or the positioning measurement result are obtained by the LMF network element according to the positioning request. Alternatively, or additionally, the positioning procedure is the procedure for positioning the terminal based on the LCS. For example, after receiving the described request message, the LMF network element performs step 3a or step 3b in the procedure as illustrated in FIG. 3, so as to obtain the location information of the terminal and/or the positioning measurement result.

At step 1006, the location information of the terminal and/or the positioning measurement result are transmitted to the network device.

After obtaining the location information of the terminal and/or the positioning measurement result, the LMF network element transmits the location information of the terminal and/or the positioning measurement result to the network device. Alternatively, or additionally, the LMF network element transmits the location information of the terminal and/or the positioning measurement result to the network device through an NRPPa message. The NRPPa message includes at least one of the UE association NRPPa message or the non-UE association NRPPa message. The message transmitted by the LMF network element may also be called a location service response.

In view of the above, by transmitting the request message, which makes a request to position the terminal and/or obtain the location information of the terminal, from the network device to the LMF network element according to the method provided in the example, it can be achieved to initiate the positioning request for the terminal by the base station, and it is thereby achieved to flexibly initiate the positioning request for the terminal.

FIG. 11 illustrates a flowchart of a terminal positioning request method according to an example of the present disclosure. The method may be applied to an AMF network element. The method includes the following steps.

At step 1102, a request message transmitted by a network device is received.

The request message makes a request to position a terminal and/or obtain location information of the terminal. For example, the network device is a base station such as a gNB. Alternatively, or additionally, the request message is a location service request.

Alternatively, or additionally, the request message requests the LMF network element to initiate a positioning request for the terminal in accordance with a positioning procedure. The positioning procedure is a procedure for positioning the terminal based on an LCS. For example, the positioning procedure is the procedure for positioning the terminal as illustrated in FIG. 3.

Alternatively, or additionally, the request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of a positioning capability based on UL-TDOA or a positioning capability based on UL-AOA. The positioning technology recommended by the network device includes at least one of a UL-TDOA technology, a UL-AOA technology or a DL-TDOA technology.

Alternatively, or additionally, when transmitting the request message to the AMF network element, the network device transmits the described request message to the AMF network element through an NG interface.

At step 1104, the location information of the terminal and/or a positioning measurement result are transmitted to the network device.

After receiving the described request message, the AMF network element transmits a positioning request message to an LMF network element in response to the request message, so as to trigger the LMF network element to initiate the positioning request for the terminal in accordance with the positioning procedure. Alternatively, or additionally, the request message is the location service request. The LMF network element initiates the positioning request for the terminal in accordance with the positioning procedure, so as to obtain the location information of the terminal and/or a positioning measurement result. Then, the LMF network element transmits the location information of the terminal and/or the positioning measurement result to the AMF network element. That is, the location information of the terminal and/or the positioning measurement result obtained by the AMF network element are obtained by the LMF network element according to the positioning request and transmitted to the AMF network element. Alternatively, or additionally, the positioning procedure is the procedure for positioning the terminal based on the LCS.

After obtaining the location information of the terminal and/or the positioning measurement result, the LMF network element transmits the location information of the terminal and/or the positioning measurement result to the AMF network element.

Alternatively, or additionally, the positioning request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of the positioning capability based on UL-TDOA or the positioning capability based on UL-AOA. The positioning technology recommended by the network device includes at least one of the UL-TDOA technology, the UL-AOA technology or the DL-TDOA technology. Alternatively, or additionally, the information in the described request message is identical to or different from the information in the positioning request message.

After obtaining the location information of the terminal and/or the positioning measurement result, the AMF network element transmits the location information of the terminal and/or the positioning measurement result to the network device. Alternatively, or additionally, the AMF network element transmits the location information of the terminal and/or the positioning measurement result to the network device through the NG interface. The message transmitted by the AMF network element may also be called a location service response.

In view of the above, by transmitting the request message, which makes a request to position the terminal and/or obtain the location information of the terminal, from the network device to the AMF network element according to the method provided in the example, it can be achieved to initiate the positioning request for the terminal by the base station, and it is thereby achieved to flexibly initiate the positioning request for the terminal.

According to the methods provided in the examples of the present disclosure, the request message may be transmitted from the network device to the AMF network element or to the LMF network element. The request message makes a request to position the terminal and/or obtain the location information of the terminal, which can achieve that the base station initiates the positioning request for the terminal. The above scheme is described through two examples below.

### In the Case Where the Network Device Transmits the Request Message to the LMF Network Element

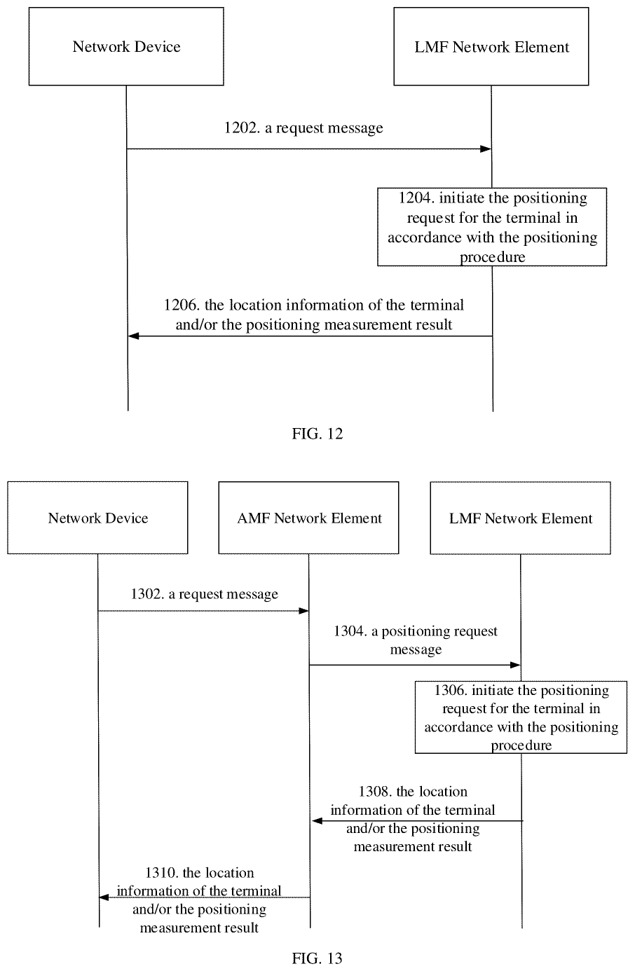

FIG. 12 illustrates a flowchart of a terminal positioning request method according to an example of the present disclosure. The method may be applied to a system illustrated in FIGS. 1 and 2. The method includes the following steps.

At step 1202, the network device transmits the request message to the LMF network element.

The request message makes a request to position the terminal and/or obtain the location information of the terminal. For example, the network device is a base station such as a gNB. Alternatively, or additionally, the request message is a location service request.

Alternatively, or additionally, the request message requests the LMF network element to initiate a positioning request for the terminal in accordance with a positioning procedure. The positioning procedure is a procedure for positioning the terminal based on an LCS. For example, the positioning procedure is the procedure for positioning the terminal as illustrated in FIG. 3.

Alternatively, or additionally, the request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of a positioning capability based on UL-TDOA or a positioning capability based on UL-AOA. The positioning technology recommended by the network device includes at least one of a UL-TDOA technology, a UL-AOA technology or a DL-TDOA technology.

Alternatively, or additionally, when transmitting the described request message to the LMF network element, the network device transmits an NRPPa message to the LMF network element, with the NRPPa message carrying the request message. The NRPPa message includes at least one of a UE association NRPPa message or a non-UE association NRPPa message.

At step 1204, the LMF network element initiates the positioning request for the terminal in accordance with the positioning procedure.

After receiving the described request message, the LMF network element initiates the positioning request for the terminal in accordance with the positioning procedure in response to the request message, so as to obtain the location information of the terminal and/or a positioning measurement result. That is, the location information of the terminal and/or the positioning measurement result are obtained by the LMF network element according to the positioning request. Alternatively, or additionally, the positioning procedure is the procedure for positioning the terminal based on the LCS. For example, after receiving the described request message, the LMF network element performs step 3a or step 3b in the procedure as illustrated in FIG. 3, so as to obtain the location information of the terminal and/or the positioning measurement result.

At step 1206, the LMF network element transmits the location information of the terminal and/or the positioning measurement result to the network device.

After obtaining the location information of the terminal and/or the positioning measurement result, the LMF network element transmits the location information of the terminal and/or the positioning measurement result to the network device. Alternatively, or additionally, the LMF network element transmits the location information of the terminal and/or the positioning measurement result to the network device through an NRPPa message. The NRPPa message includes at least one of the UE association NRPPa message or the non-UE association NRPPa message. The message transmitted by the LMF network element may also be called a location service response.

In view of the above, by transmitting the request message, which makes a request to position the terminal and/or obtain the location information of the terminal, from the network device to the LMF network element according to the method provided in the example, it can be achieved to initiate the positioning request for the terminal by the base station, and it is thereby achieved to flexibly initiate the positioning request for the terminal.

### In the Case Where the Network Device Transmits the Request Message to the AMF Network Element

FIG. 13 illustrates a flowchart of a terminal positioning request method according to an example of the present disclosure. The method may be applied to a system illustrated in FIGS. 1 and 2. The method includes the following steps.

At step 1302, the network device transmits the request message to the AMF network element.

The request message makes a request to position the terminal and/or obtain the location information of the terminal. For example, the network device is a base station such as a gNB. Alternatively, or additionally, the request message is a location service request.

Alternatively, or additionally, the request message requests the LMF network element to initiate a positioning request for the terminal in accordance with a positioning procedure. The positioning procedure is a procedure for positioning the terminal based on an LCS. For example, the positioning procedure is the procedure for positioning the terminal as illustrated in FIG. 3. Alternatively, or additionally, the request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of a positioning capability based on UL-TDOA or a positioning capability based on UL-AOA. The positioning technology recommended by the network device includes at least one of a UL-TDOA technology, a UL-AOA technology or a DL-TDOA technology.

Alternatively, or additionally, when transmitting the request message to the AMF network element, the network device transmits the described request message to the AMF network element through an NG interface.

At step 1304, the AMF network element transmits a positioning request message to an LMF network element.

After receiving the described request message, the AMF network element transmits a positioning request message to the LMF network element in response to the request message, so as to trigger the LMF network element to initiate the positioning request for the terminal in accordance with the positioning procedure. Alternatively, or additionally, the request message is the location service request.

Alternatively, or additionally, the positioning request message includes at least one piece of the following information:
a purpose and/or a reason for requesting the location information of the terminal;
a positioning capability of the terminal; or
a positioning technology recommended by the network device.

For example, the purpose of requesting the location information of the terminal includes verifying the location information reported by the terminal. The positioning capability of the terminal includes at least one of the positioning capability based on UL-TDOA or the positioning capability based on UL-AOA. The positioning technology recommended by the network device includes at least one of the UL-TDOA technology, the UL-AOA technology or the DL-TDOA technology. Alternatively, or additionally, the information in the described request message is identical to or different from the information in the positioning request message.

At step 1306, the LMF network element initiates the positioning request for the terminal in accordance with the positioning procedure.

After receiving the described positioning request message, the LMF network element initiates the positioning request for the terminal in accordance with the positioning procedure, so as to obtain the location information of the terminal and/or a positioning measurement result. That is, the location information of the terminal and/or the positioning measurement result are obtained by the LMF network element according to the positioning request. Alternatively, or additionally, the positioning procedure is the procedure for positioning the terminal based on the LCS. For example, after receiving the described positioning request message, the LMF network element performs step 3a or step 3b in the procedure as illustrated in FIG. 3, so as to obtain the location information of the terminal and/or the positioning measurement result.

At step 1308, the AMF network element receives the location information of the terminal and/or the positioning measurement result transmitted by the LMF network element.

After obtaining the location information of the terminal and/or the positioning measurement result in accordance with the positioning procedure, the LMF network element transmits the location information of the terminal and/or the positioning measurement result to the AMF network element (e.g., transmitting a location service response). That is, the location information of the terminal and/or the positioning measurement result obtained by the AMF network element are obtained by the LMF network element according to the positioning request and transmitted to the AMF network element.

At step 1310, the AMF network element transmits the location information of the terminal and/or the positioning measurement result to the network device.

After obtaining the location information of the terminal and/or the positioning measurement result, the AMF network element transmits the location information of the terminal and/or the positioning measurement result to the network device. Alternatively, or additionally, the AMF network element transmits the location information of the terminal and/or the positioning measurement result to the network device through the NG interface. The message transmitted by the AMF network element may also be called the location service response.

In view of the above, by transmitting the request message, which makes a request to position the terminal and/or obtain the location information of the terminal, from the network device to the AMF network element according to the method provided in the example, it can be achieved to initiate the positioning request for the terminal by the base station, and it is thereby achieved to flexibly initiate the positioning request for the terminal.

It is to be noted that the order of the method steps provided in the examples of the present disclosure may be appropriately adjusted, and the steps may be increased or decreased accordingly according to the circumstances. Any skilled in the art may easily think of changed methods within the technical scope disclosed in the present disclosure, and they should be covered by the protection scope of the present disclosure, which are not repeated here.

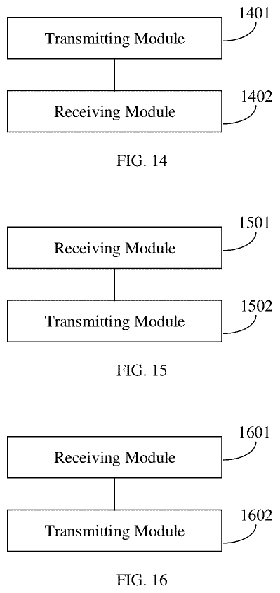

FIG. 14 illustrates a structural diagram of a terminal positioning request apparatus according to an example of the present disclosure. As illustrated in FIG. 14, the apparatus includes:
a transmitting module 1401 that is configured to transmit a request message to an AMF network element or an LMF network element.

The request message makes a request to position a terminal and/or obtain location information of the terminal.

In an alternative or additional design, the request message requests the AMF network element or the LMF network element to initiate a positioning request for the terminal in accordance with a positioning procedure.

In an alternative or additional design, the transmitting module 1401 is configured to: transmit an NRPPa message to the LMF network element.

The NRPPa message carries the request message.

In an alternative or additional design, the LMF network element initiates the positioning request for the terminal in accordance with the positioning procedure in response to the request message.

In an alternative or additional design, the apparatus further includes:
a receiving module 1402 that is configured to receive the location information of the terminal and/or a positioning measurement result transmitted by the LMF network element.

The location information of the terminal and/or the positioning measurement result are obtained by the LMF network element according to the positioning request.

In an alternative or additional design, the transmitting module 1401 is configured to:
transmit the request message to the AMF network element through an NG interface.

In an alternative or additional design, the AMF network element triggers, in response to the request message and by transmitting a positioning request message to the LMF network element, the LMF network element to initiate the positioning request for the terminal in accordance with the positioning procedure.

In an alternative or additional design, the apparatus further includes:
a receiving module 1402 that is configured to receive the location information of the terminal and/or the positioning measurement result transmitted by the AMF network element.

The location information of the terminal and/or the positioning measurement result are obtained by the LMF network element according to the positioning request and transmitted to the AMF network element.

In an alternative or additional design, the receiving module 1402 is configured to:
receive, through the NG interface, the location information of the terminal and/or the positioning measurement result transmitted by the AMF network element.

In an alternative or additional design, the positioning procedure is a procedure for positioning the terminal based on an LCS.

In an alternative or additional design, the request message includes at least one piece of the following information:
a purpose and/or a reason for requesting the location information of the terminal;
a positioning capability of the terminal; or
a positioning technology recommended by the device.

FIG. 15 illustrates a structural diagram of a terminal positioning request apparatus according to an example of the present disclosure. As illustrated in FIG. 15, the apparatus includes:
a receiving module 1501 that is configured to receive a request message transmitted by a network device.

The request message makes a request to position a terminal and/or obtain location information of the terminal.

In an alternative or additional design, the receiving module 1501 is configured to:
receive an NRPPa message transmitted by the network device.

The NRPPa message carries the request message.

In an alternative or additional design, the apparatus further includes:
a transmitting module 1502 that is configured to initiate a positioning request for the terminal in accordance with a positioning procedure.

The transmitting module 1502 is configured to transmit the location information the terminal and/or a positioning measurement result to the network device.

The location information of the terminal and/or the positioning measurement result are obtained by the apparatus according to the positioning request.

In an alternative or additional design, the positioning procedure is a procedure for positioning the terminal based on an LCS.

In an alternative or additional design, the request message includes at least one piece of the following information:
a purpose and/or a reason for requesting the location information of the terminal;
a positioning capability of the terminal; or
a positioning technology recommended by the network device.

FIG. 16 illustrates a structural diagram of a terminal positioning request apparatus according to an example of the present disclosure. As illustrated in FIG. 16, the apparatus includes:
a receiving module 1601 that is configured to receive a request message transmitted by a network device.

The request message makes a request to position a terminal and/or obtain location information of the terminal.

In an alternative or additional design, the receiving module 1601 is configured to:
receive, through an NG interface, the request message transmitted by the network device.

In an alternative or additional design, the apparatus further includes:
a transmitting module 1602 that is configured to transmit the location information the terminal and/or a positioning measurement result to the network device.

In an alternative or additional design, the transmitting module 1602 is configured to: transmit a positioning request message to an LMF network element.

The receiving module 1601 is configured to receive the location information of the terminal and/or the positioning measurement result transmitted by the LMF network element.

The positioning request message triggers the LMF network element to initiate a positioning request for the terminal in accordance with a positioning procedure. The location information of the terminal and/or the positioning measurement result are obtained by the LMF network element according to the positioning request.

In an alternative or additional design, the transmitting module 1602 is configured to:
transmit the location information of the terminal and/or the positioning measurement result to the network device through the NG interface.

In an alternative or additional design, the request message includes at least one piece of the following information:
a purpose and/or a reason for requesting the location information of the terminal;
a positioning capability of the terminal; or
a positioning technology recommended by the network device.

It is to be noted that the division of the above functional modules is only taken as an example for illustrating how to realize the functions of each apparatus provided in the above examples. In actual applications, the above functions can be assigned to different functional modules for completion according to actual needs. That is, the internal structure of the apparatus may be divided into different functional modules to complete all or a part of the described functions.

With respect to the apparatus in the foregoing examples, the specific manner in which each module performs its operation has been described in detail in the examples of the related methods, and will not be further elaborated here.

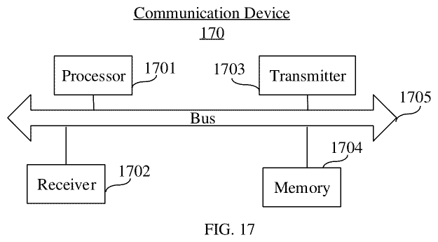

FIG. 17 illustrates a schematic structural diagram of a communication device (e.g., a terminal or a network device) according to an example of the present disclosure. The communication device 170 includes: a processor 1701, a receiver 1702, a transmitter 1703, a memory 1704 and a bus 1705.

The processor 1701 includes one or more processing cores. The processor 1701 performs various functional applications and information processing by running software programs and modules.

The receiver 1702 and the transmitter 1703 may be implemented as a communication component, which may be a communication chip.

The memory 1704 is connected to the processor 1701 through the bus 1705.

The memory 1704 may be configure to store at least one instruction, and the processor 1701 is configured to execute the at least one instruction to implement various steps of the described method examples.

In addition, the memory 1704 may be implemented by any type of volatile or non-volatile storage device or a combination thereof. The volatile or non-volatile storage device includes but is not limited to: a magnetic disk or an optical disk, an electrically erasable programmable read-only memory (EEPROM), an erasable and programmable read-only memory (EPROM), a static random access memory (SRAM), a read-only memory (ROM), a magnetic memory, a flash memory, or a programmable read-only memory (PROM).

When the communication device is implemented as an LMF network element or an AMF network element, one or more processors and one or more transceivers in the communication device involved in the examples of the present disclosure may be implemented together as a communication chip. Alternatively, the one or more transceivers may form a communication chip by themselves. One or more transmitter in the one or more transceivers perform the transmitting steps performed by the LMF network element or the AMF network element in any one of the methods illustrated above, one or more receivers in the one or more transceivers perform the receiving steps performed by the LMF network element or the AMF network element in any one of the methods illustrated above, and the one or more processors perform the steps other than the transmitting and receiving steps, which are not repeated here.

When the communication device is implemented as a network device (e.g., an access network device), one or more processors and one or more transceivers in the communication device involved in the examples of the present disclosure may be implemented together as a communication chip. Alternatively, one or more transceivers may form a communication chip by themselves. One or more transmitters in the one or more transceivers perform the transmitting steps performed by the network device in any one of the methods illustrated above, one or more receivers in the one or more transceivers perform the receiving steps performed by the network device in any one of the methods illustrated above, and the one or more processors perform the steps other than the transmitting and receiving steps, which are not repeated here.

In an example, a computer-readable storage medium is also provided, in which at least one instruction, at least one program, a code set or an instruction set is stored. The at least one instruction, the at least one program, the code set or the instruction set is loaded and executed by one or more processors to implement the terminal positioning request methods provided in the various described method examples.

In an example, a chip is provided. The chip includes a programmable logic circuit and/or program instructions. When running on a communication device, the chip is configured to implement the terminal positioning request methods provided in the various described method examples.

In an example, a computer program product is further provided. When running on one or more processors of a computer, the computer program product enables the computer to perform the described terminal positioning request methods.

Those skilled in the art should be appreciated that in one or more foregoing examples, the function described in the examples of the present disclosure may be implemented in hardware, software, firmware, or any combination thereof. When implemented in software, these functions may be stored in a computer-readable medium or transmitted as one or more instructions or codes of the computer-readable medium. The computer-readable medium includes a computer storage medium and a communication medium. The communication medium includes any medium that facilitates the transmission of a computer program from one place to another. The storage medium may be any available medium that can be accessed by a general-purpose or special-purpose computer.

The above are only some examples of the present disclosure, and are not intended to limit the present disclosure. Any modifications, equivalent replacements, improvements, etc. made within the spirit and principles of the present disclosure shall be included in the protection scope of the present disclosure.

1. A terminal positioning request method, performed by a network device, the method comprising:
transmitting a request message to an access and mobility management function (AMF) network element or a location management function (LMF) network element, wherein the request message makes a request to perform at least one of positioning a terminal or obtaining location information of the terminal.

2. The method according to claim 1, wherein the request message requests the AMF network element or the LMF network element to initiate a positioning request for the terminal in accordance with a positioning procedure.

3. The method according to claim 1, wherein transmitting the request message to the AMF network element or the LMF network element comprises:
transmitting the request message to the AMF network element through a next generation (NG) interface; or
transmitting a new radio positioning protocol A (NRPPa) message to the LMF network element, wherein the NRPPa message carries the request message.

4. The method according to claim 1, wherein transmitting the request message to the LMF network element enables the LMF network element to initiate a positioning request for the terminal in accordance with a positioning procedure in response to the request message.

5. The method according to claim 4, further comprising:
receiving at least one of the location information of the terminal or a positioning measurement result transmitted by the LMF network element,
wherein the at least one of the location information of the terminal or the positioning measurement result is obtained by the LMF network element according to the positioning request.

6. (canceled)

7. The method according to claim 1, wherein transmitting the request message to the AMF network element enables the LMF network element to trigger, in response to the request message and by transmitting a positioning request message to the LMF network element, the LMF network element to initiate a positioning request for the terminal in accordance with a positioning procedure.

8. The method according to claim 7, further comprising:
receiving at least one of the location information of the terminal or a positioning measurement result transmitted by the AMF network element,
wherein the at least one of the location information of the terminal or the positioning measurement result is obtained by the LMF network element according to the positioning request and transmitted to the AMF network element.

9. The method according to claim 8, wherein receiving the at least one of the location information of the terminal or the positioning measurement result transmitted by the AMF network element comprises:
receiving, through a next generation (NG) interface, the at least one of the location information of the terminal or the positioning measurement result transmitted by the AMF network element.

10. The method according to claim 2, wherein the positioning procedure is a procedure for positioning the terminal based on a location service (LCS).

11. The method according to claim 9, wherein the request message comprises at least one piece of the following information:
at least one of a purpose or a reason for requesting the location information of the terminal;
a positioning capability of the terminal; or
a positioning technology recommended by the network device.

12. A terminal positioning request method, performed by a location management function (LMF) network element, the method comprising:
receiving a request message transmitted by a network device,
wherein the request message makes a request to perform at least one of positioning a terminal or obtaining location information of the terminal.

13. (canceled)

14. The method according to claim 12, further comprising:
initiating a positioning request for the terminal in accordance with a positioning procedure; and
transmitting at least one of the location information of the terminal or a positioning measurement result to the network device,
wherein the at least one of the location information of the terminal or the positioning measurement result is obtained by the LMF network element according to the positioning request.

15. (canceled)

16. The method according to claim 12, wherein the request message comprises at least one piece of the following information:
at least one of a purpose or a reason for requesting the location information of the terminal;
a positioning capability of the terminal; or
a positioning technology recommended by the network device.

17. A terminal positioning request method, performed by an access and mobility management function (AMF) network element, the method comprising:
receiving a request message transmitted by a network device,
wherein the request message makes a request to perform at least one of positioning a terminal or obtaining location information of the terminal.

18. (canceled)

19. The method according to claim 17, further comprising:
transmitting at least one of the location information of the terminal or a positioning measurement result to the network device.

20. The method according to claim 19, further comprising:
transmitting a positioning request message to a location management function (LMF) network element; and
receiving the at least one of the location information of the terminal or the positioning measurement result transmitted by the LMF network element,
wherein the positioning request message triggers the LMF network element to initiate a positioning request for the terminal in accordance with a positioning procedure, and wherein the at least one of the location information of the terminal or the positioning measurement result is obtained by the LMF network element according to the positioning request.

21. (canceled)

22. The method according to claim 17, wherein the request message comprises at least one piece of the following information:
at least one of a purpose or a reason for requesting the location information of the terminal;
a positioning capability of the terminal; or
a positioning technology recommended by the network device.

23.-25. (Canceled)

26. A network device, comprising:
one or more processors;
one or more transceivers connected to the one or more processors; and
one or more memories for storing executable instructions of the one or more processors;
wherein the one or more processors are configured to perform the terminal positioning request method according to claim 1.

27. (canceled)

28. (canceled)

29. A network device, comprising:
one or more processors;
one or more transceivers connected to the one or more processors; and
one or more memories for storing executable instructions of the one or more processors;
wherein the one or more processors are configured to perform the terminal positioning request method according to claim 12.

30. A network device, comprising:
one or more processors;
one or more transceivers connected to the one or more processors; and
one or more memories for storing executable instructions of the one or more processors;
wherein the one or more processors are configured to perform the terminal positioning request method according to claim 17.
